(19) United States
(12) Patent Application Publication
(10) Pub. No.: US 2016/0291852 A1
(43) Pub. Date: Oct. 6, 2016

(54) METHOD AND SYSTEM FOR PROVIDING ZOOM-CONTROLLED TRANSPORTATION ROUTE MAP OR ROAD MAP

(71) Applicant: NAVER Corporation, Seongnam-si (KR)

(72) Inventors: Hyo Jung Kim, Seongnam-si (KR); Hyun-Soo Kim, Seongnam-si (KR); Soo-Eui Sung, Seongnam-si (KR); Rae Na, Seongnam-si (KR); HeeJeong Son, Seongnam-si (KR)

(21) Appl. No.: 15/087,340

(22) Filed: Mar. 31, 2016

(30) Foreign Application Priority Data
Mar. 31, 2015 (KR) 10-2015-0045095

(51) Int. Cl. G06F 3/0484; G06F 3/0481; G01C 21/36; G09G 5/373

(52) U.S. Cl. CPC G06F 3/04845; G09G 5/373; G06F 3/04842; G06F 3/0481; G01C 21/367; G09G 2340/045

(57) ABSTRACT

A zoom control method includes identifying or receiving position information including a current position or a departure position associated with a user, displaying a transportation route map or a road map including the position information on a display of a terminal, determining that a preset period of time has elapsed from a display point in time, and displaying the transportation route map or the road map on the display of the terminal through an auto zoom-out or an auto zoom-in, wherein the displaying of the transportation route map or the road map on the display of the terminal through the auto zoom-out or the auto zoom-in includes marking the position information on the auto zoomed-out or zoomed-in transportation route map or road map.

### CROSS-REFERENCE TO RELATED APPLICATION(S)

This application claims priority under 35 U.S.C. §119 to Korean Patent Application No. 10-2015-0045095 filed Mar. 31, 2015, in the Korean Intellectual Property Office (KIPO), the entire contents of which are incorporated herein by reference.

### BACKGROUND

1. Field

One or more exemplary embodiments of the present invention relate to technology for guiding route information or a map, and more particularly, to a method and system for providing a zoom-in/zoom-out function on a transportation route map or a road map.

2. Description of Related Art

In response to a user access to a subway map application through a mobile communication terminal, the subway map application outputs the entire route based on the center of the subway map.

Also, the subway map application provides a guide system and method for finding a subway line suitable for a user desired time with respect to a route from a departure location to a destination input from the user, by detecting the shortest route from the departure location to the destination, and by transmitting, to the mobile communication terminal, the departure time or the destination arrival time information of the user including the waiting time at a transfer station for each detected shortest route, the shortest route from the departure location to the destination, and timetable information of the subway line the user is to take.

The related art may provide the user with unilateral information, such as a current state, an estimated arrival time of a public transportation on the route, and the like, and may not provide a user-oriented route map capable of verifying position information of the user and easily conducting a route search.

### SUMMARY

One or more exemplary embodiments of the present invention provide a zoom control method and system that may provide an auto zoomed-out transportation route map or road map based on position information of a user.

One or more exemplary embodiments also provide a zoom control method and system that may provide an auto zoomed-in transportation route map or road map based on position information of a user.

According to an aspect, there is provided a zoom control method executed by a computer, the method including identifying or receiving position information including a current position or a departure position associated with a user, displaying a transportation route map or a road map including the position information on a display of a terminal, determining that a preset period of time has elapsed from a display point in time; and displaying the transportation route map or the road map on the display of the terminal through an auto zoom-out or an auto zoom-in, wherein the displaying of the transportation route map or the road map on the display of the terminal through the auto zoom-out or the auto zoom-in includes marking the position information on the auto zoomed-out or zoomed-in transportation route map or road map.

The displaying of the transportation route map or the road map including the position information on the display of the terminal may include marking a station close to the position information on the transportation route map or marking a point corresponding to the position information on the road map.

The displaying of the transportation route map or the road map on the display of the terminal through the auto zoom-out or the auto zoom-in may include reducing the transportation route map or the road map by performing the auto zoom-out based on a zoom level.

The displaying of the transportation route map or the road map including the position information on the display of the terminal may include providing an interface for receiving the position information, and marking a point corresponding to a departure position selected by the user and a point corresponding to an arrival position selected by the user.

The displaying of the transportation route map or the road map including the position information on the display of the terminal may include marking a departure position name in response to the departure position selected by the user and an arrival position name in response to the arrival position selected by the user.

The displaying of the transportation route map or the road map including the position information on the display of the terminal may include displaying the entire route by connecting the departure position and the arrival position selected by the user.

The displaying of the transportation route map or the road map on the display of the terminal through the auto zoom-out or the auto zoom-in may include enlarging a route of a range including the position information by performing the auto zoom-in on a route of a range including the departure position.

The displaying of the transportation route map or the road map on the display of the terminal through the auto zoom-out or the auto zoom-in may include performing the auto zoom-in on a route of a range including a departure station on the entire route that connects the departure station and an arrival station selected by the user on the transportation route map.

According to another aspect, there is provided a non-transitory computer readable medium including instructions for controlling a computer system, wherein the instructions control the computer system to execute the steps including identifying or receiving position information including a current position or a departure position associated with a user, displaying a transportation route map or a road map including the position information on a display of a terminal, determining that a preset period of time has elapsed from a display point in time, and displaying the transportation route map or the road map on the display of the terminal through an auto zoom-out or an auto zoom-in, and the displaying of the transportation route map or the road map on the display of the terminal through the auto zoom-out or the auto zoom-in includes marking the position information on the auto zoomed-out or zoomed-in transportation route map or road map.

According to another aspect, there is provided a zoom control system configured as a computer, including an identifier configured to identify or receive position information including a current position or a departure position associated with a user, a position information display configured to display a transportation route map or a road map including the position information on a display of a terminal, and an executor configured to determine that a preset period of time has elapsed from a display point in time, and to display the transportation route map or the road map on the display of the terminal through an auto zoom-out or an auto zoom-in, wherein the executor is further configured to mark the position information on the auto zoomed-out or zoomed-in transportation route map or road map.

The position information display may be further configured to mark a station close to the position information on the transportation route map or mark a point corresponding to the position information on the road map.

The executor may be further configured to reduce the transportation route map or the road map by performing the auto zoom-out based on a zoom level.

The position information display may be further configured to provide an interface for receiving the position information, and to mark a point corresponding to a departure position selected by the user and a point corresponding to an arrival position selected by the user.

The position information display may be further configured to mark a departure position name in response to the departure position selected by the user and an arrival position name in response to the arrival position selected by the user.

The position information display may be further configured to display the entire route by connecting the departure position and the arrival position selected by the user.

The executor may be further configured to enlarge a route of a range including the position information by performing the auto zoom-in on a route of a range including the departure position.

The executor may be further configured to perform the auto zoom-in on a route of a range including a departure station in the entire route that connects the departure station and an arrival station selected by the user on the transportation route map.

A zoom control system and method according to one or more example embodiments may facilitate a search by executing an auto zoom-out on a road map or a transportation route map based on position information of a user and by marking a position of the user on the auto zoomed out road map or transportation route map.

A zoom control system and method according to one or more example embodiments may provide an enlarged road map or transportation route map by displaying all routes that connect a departure location and an arrival location, and by executing an auto zoom-in on the road map or the transportation route map based on the departure location of the user.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an environment between a zoom control system and a user terminal according to one exemplary embodiment;

FIG. 2 is a block diagram illustrating a configuration of a zoom control system according to one exemplary embodiment;

FIG. 3 illustrates an example of a zoom-out performed at a zoom control system according to one exemplary embodiment;

FIG. 4 illustrates an example of a zoom-in performed at a zoom control system according to one exemplary embodiment;

FIG. 5 is a flowchart illustrating a zoom-out method of a zoom control system according to one exemplary embodiment;

FIG. 6 is a flowchart illustrating a zoom-in method of a zoom control system according to one exemplary embodiment; and

FIG. 7 is a block diagram illustrating a configuration of a computer system according to one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more exemplary embodiments of the present invention will be described in detail with reference to the accompanying drawings. Exemplary embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some exemplary embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Exemplary embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more exemplary embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more exemplary embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more exemplary embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

A zoom control system and method according to one or more exemplary embodiments relates to technology for providing a transportation route map or a road map, and may be applicable to a variety of fields, such as a map search service, a position verification service, a route find/route guide service, and the like.

The term “transportation route map” used herein indicates routes, stops, and stations used to arrange a geographical area in which a mode of transportation operates, including a subway, a bus, a train, an airplane, and the like. Hereinafter, a description will be made by using a subway map as a representative example of the transportation route map.

Hereinafter, one or more exemplary embodiments will be described with reference to the accompanying drawings.

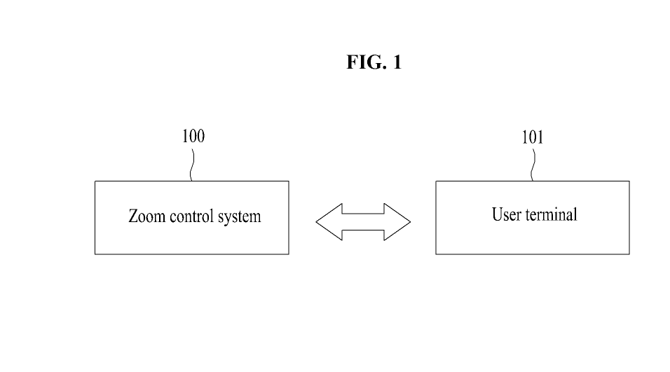

FIG. 1 is a diagram illustrating an environment between a zoom control system and a user terminal according to one exemplary embodiment. FIG. 1 illustrates a zoom control system 100 and a user terminal 101. In FIG. 1, an indicator with arrowheads indicates that data may be transmitted and received between the zoom control system 100 and the user terminal 101 over a wired/wireless network.

The user terminal 101 may be, for example, a personal computer (PC), a laptop computer, a smartphone, a tablet, a wearable computer, and the like, and may refer to any type of terminal devices capable of connecting to a website/mobile site associated with the zoom control system 100 or installing and executing a service exclusive application. Here, the user terminal 101 may perform the overall service operation, such as a service screen configuration, data input, data transmission and reception, data storage, and the like, under control of the website/mobile site or the exclusive application.

The zoom control system 100 serves as a service platform that provides a transportation route map or a road map to the user terminal 101 that is a client. The zoom control system 100 may provide a transportation route map or a road map automatically zoomed out or zoomed in by performing an auto zoom-out or an auto zoom-in based on position information recognized from the user terminal 101.

The zoom control system 100 may be configured in an application form on the user terminal 101, and without being limited thereto, may be configured to be included in a service platform that provides a transportation route map and a road map in a client-server environment. The zoom control system 100 may be configured as a single system with a service platform that provides a transportation route map or a road map, or may be configured as a system separate from a map service platform and thereby interact therewith.

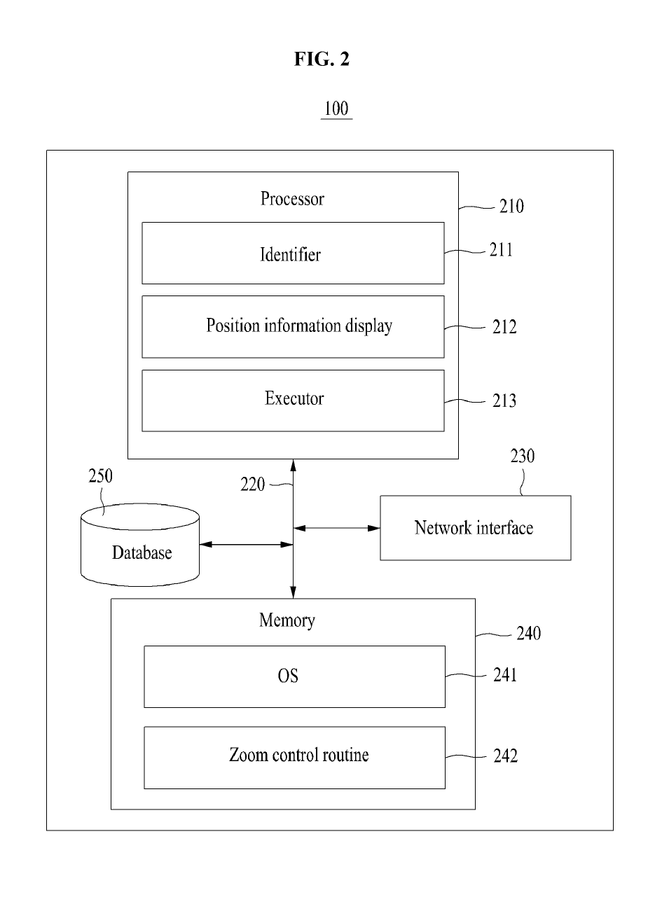

FIG. 2 is a block diagram illustrating a configuration of the zoom control system 100 according to one exemplary embodiment.

Referring to FIG. 2, a zoom control system 100 includes a processor 210, a bus 220, a network interface 230, a memory 240, and a database 250. The memory 240 may include an operating system (OS) 241 and a zoom control routine 242. The processor 210 includes an identifier unit 211, a position information display unit 212, and an executor unit 213. According to other example embodiments, the zoom control system 100 may include a greater or less number of constituent elements than the number of constituent elements shown in FIG. 2.

The memory 240 may include a permanent mass storage device, such as random access memory (RAM), read only memory (ROM), a disk drive, etc., as a computer-readable storage medium. Also, program codes (e.g., computer-readable instructions) for the OS 241 and the zoom control routine 242 may be stored in the memory 240. Such software constituent elements may be loaded from another computer-readable storage medium separate from the memory 240 using a drive mechanism (not shown). The other computer-readable storage medium may include, for example, a floppy drive, a disk, a tape, a DVD/CD-ROM drive, a memory card, etc. Software constituent elements may be loaded to the memory 240 through the network interface 230 instead of, or in addition to, the computer-readable storage medium.

The bus 220 enables communication and data transmission between the constituent elements of the zoom control system 100. The bus 220 may be configured using a high-speed serial bus, a parallel bus, a storage area network (SAN), and/or another appropriate communication technology.

The network interface 230 may be a computer hardware constituent element for connecting the zoom control system 100 to the computer network. The network interface 230 may connect the zoom control system 100 to the computer network through a wireless and/or wired connection.

The database 250 serves to store and maintain all of information required to provide a transportation route map and a road map. The database 250 may be constructed such that entire route information for each item of public transportation and information associated with each point included in each route are matched to one another. Although FIG. 2 illustrates that the database 250 is included in the zoom control system 100, the database 250 may be present as an external database constructed on a separate system.

The processor 210 may be configured to process computer-readable instructions of a computer program by performing basic arithmetic operations, logic operations, and input/output operations of the zoom control system 100. The computer-readable instructions may be provided from the memory 240 and/or the network interface 230 to the processor 210 through the bus 220. The processor 210 may be configured to execute program codes for the identifier unit 211, the position information display unit 212, and the executor unit 213. The program codes may be stored in a storage device, such as the memory 240.

The identifier unit 211 identifies or receives position information including a current position or a departure position associated with a user. For example, the identifier unit 211 may identify a position of the user through global positioning system (GPS) communication with the user terminal 101 and may determine the position of the user through communication between a base station and the user terminal 101.

The position information display unit 212 displays a transportation route map or a road map including position information of the user on a display of the user terminal 101. The position information display unit 212 may mark a station close to the position information on the transportation route map or may mark a point corresponding to position information on the road map.

The position information display unit 212 may provide an interface for receiving position information, and may mark a point corresponding to a departure position selected by the user and may mark a point corresponding to an arrival position selected by the user. The position information display unit 212 may mark a departure position name in response to the departure position selected by the user and an arrival position name in response to the arrival position selected by the user. The position information display unit 212 may display the entire route that connects the departure position and the arrival position selected by the user.

The executor unit 213 determines whether a preset period of time has elapsed from a display point in time in which the transportation route map or the road map was first displayed on the display of the user terminal 101, and may display the transportation route map or the road map on the display of the user terminal 101 through an auto zoom-out or an auto zoom-in. Here, the user terminal 101 may mark the position information on the auto zoomed-out or zoomed-in transportation route map or road map through the executor unit 213.

The executor unit 213 reduces the transportation route map or the road map by performing an auto zoom-out based on a zoom level. The executor unit 213 may enlarge a range of a route including the position information by performing an auto zoom-in on a route of a range including the departure position. The executor unit 213 may perform the auto zoom-in on a range of a route including a departure station in the entire route that connects the departure station and an arrival station selected by the user on the transportation route map.

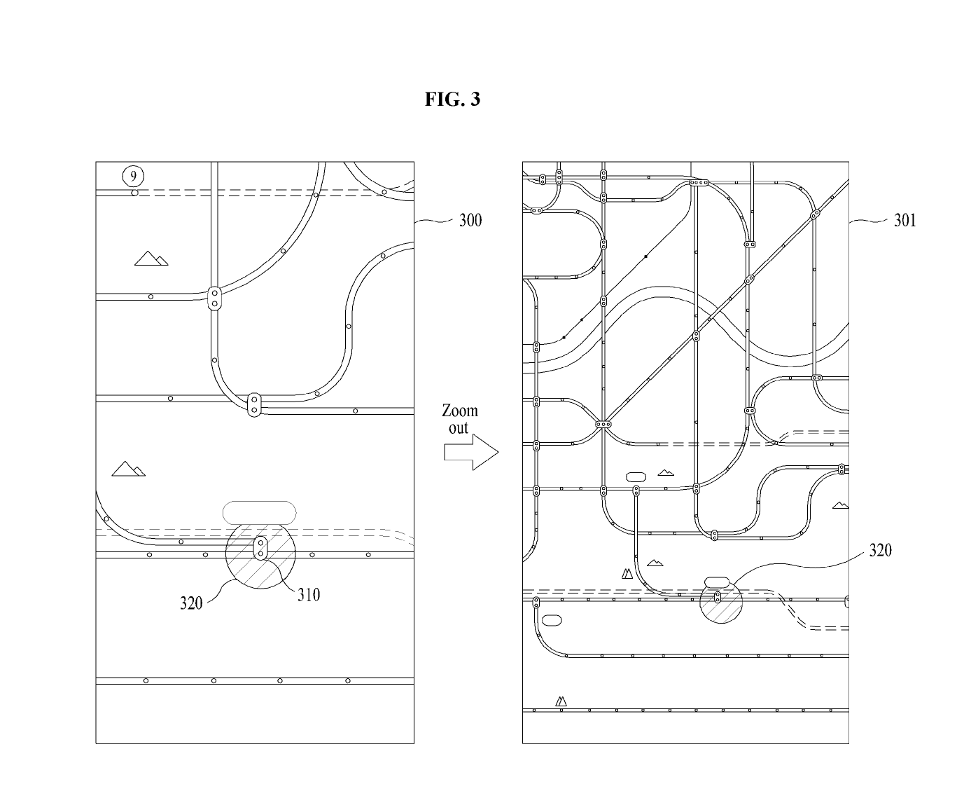

FIG. 3 illustrates an example of a zoom-out performed in a zoom control system 100 according to one exemplary embodiment.

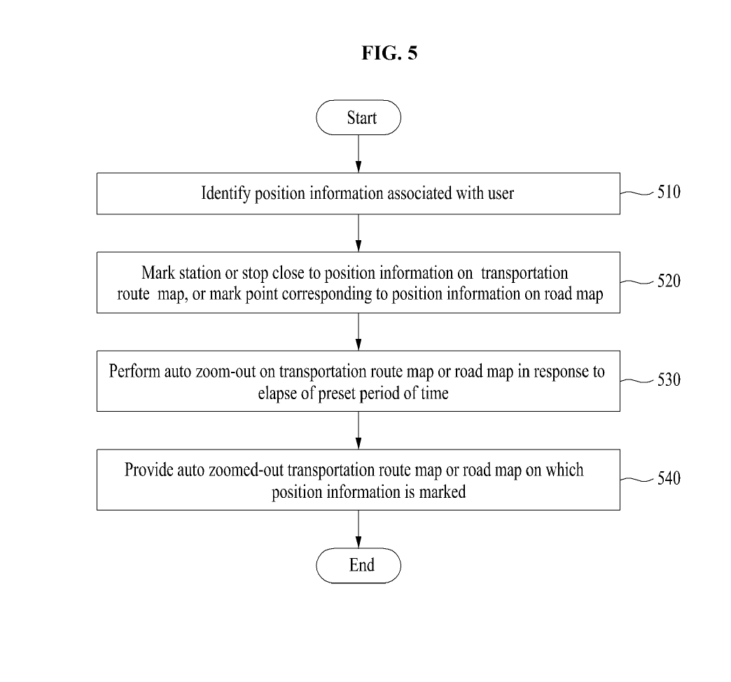

The zoom control system 100 performs the zoom-out through operations 510 through 540 of FIG. 5. Referring to FIG. 5, in operation 510, the identifier unit 211 identifies position information associated with a user.

In operation 520, the position information display unit 212 marks a station or a stop close to the position information on a transportation route map, or may mark a point corresponding to the position information on a road map.

In operation 530, the executor unit 213 performs an auto zoom-out on the transportation route map or the road map in response to elapse of a preset period of time, for example, 10 seconds. Here, the executor unit 213 may reduce the transportation route map or the road map by performing the auto zoom-out based on a preset zoom level. For example, the preset zoom level may be divided into levels (e.g., 10%) based on a reduction level, that is, a downscale level.

In operation 540, the executor unit 213 provides, to the user terminal 101, the auto zoomed-out transportation route map or road map on which the position information is marked, and may display the auto zoomed-out transportation route map or road map on a display of the user terminal. Here, the auto zoomed-out transportation route map or road map provided to the user may be reduced to a size enough for the user to read a text included on the transportation route map or the road map and thereby displayed.

The zoom control system 100 according to one exemplary embodiment may identify a position of the user and may mark the position of the user at a point on the road map or a station on the transportation route map close to the user on the user terminal 101, so that the user may conveniently search for a desired route on the road map or the transportation route map.

An example of the auto zoom-out method performed through operations 510 through 540 will be described with reference to FIG. 3. FIG. 3 illustrates a subway map 300 and it is assumed that a user has executed a subway map application through the user terminal 101.

When the user initially executes the subway map application, the identifier unit 211 may identify position information that includes a current position associated with the user through the user terminal 101. For example, the current position associated with the user may be verified through GPS communication with the user terminal and may also be verified through communication between the user terminal and a base station. In addition, various methods of determining a position of the user may be applicable. The aforementioned position determining method is only an example.

The position information display unit 212 marks the position of the user on the subway map 300 based on the position information. Here, the position of the user may be marked at a subway station close to the user. For example, when the identifier unit 211 determines that the user is present around Jeongja station 310, the position information display unit 212 may display position information 320 of the user at Jeongja station 310 through a display of the user terminal 101.

The executor unit 213 determines that a preset period of time has elapsed from a point in time which the position information 320 of the user was displayed on the display of the user terminal 101. The executor unit 213 performs an auto zoom-out and display the auto zoomed-out subway map 301 on the display of the user terminal 101. For example, the executor unit may output the auto zoomed-out subway map 301 five seconds from the point in time at which the position information 320 of the user was displayed on the display of the user terminal 101. Here, the position information 320 of the user is marked on the auto zoomed-out subway map 301.

The executor unit 213 may reduce the subway map by performing the auto zoom-out based on a zoom level. Here, the zoom level may be preset and may be set by the user. For example, the zoom level may be used to adjust a reduction level, for example, a downscale level, such as personal, middle, and the like.

For example, the position information display unit 212 may mark the position information 320 of the user at Jeongja station 310 close to the current position of the user on the subway map 300 and then the executor unit 213 performs a zoom-out. Since the executor unit 213 performs the zoom-out based on a point at which the position information 320 of the user is marked, the zoomed out subway map 301 on which Jeongja station 310 and the position information 320 of the user are marked may be displayed on the display of the user terminal 100. Here, the subway map 300 may be zoomed out so that the user may read a text included in the subway map 301.

The zoom control system 100 according to one or more exemplary embodiments may output an auto zoomed-out subway map that includes a position of a user based on position information of the user, and may mark the position information of the user on the subway map, so that the user may easily search for a user-oriented subway route.

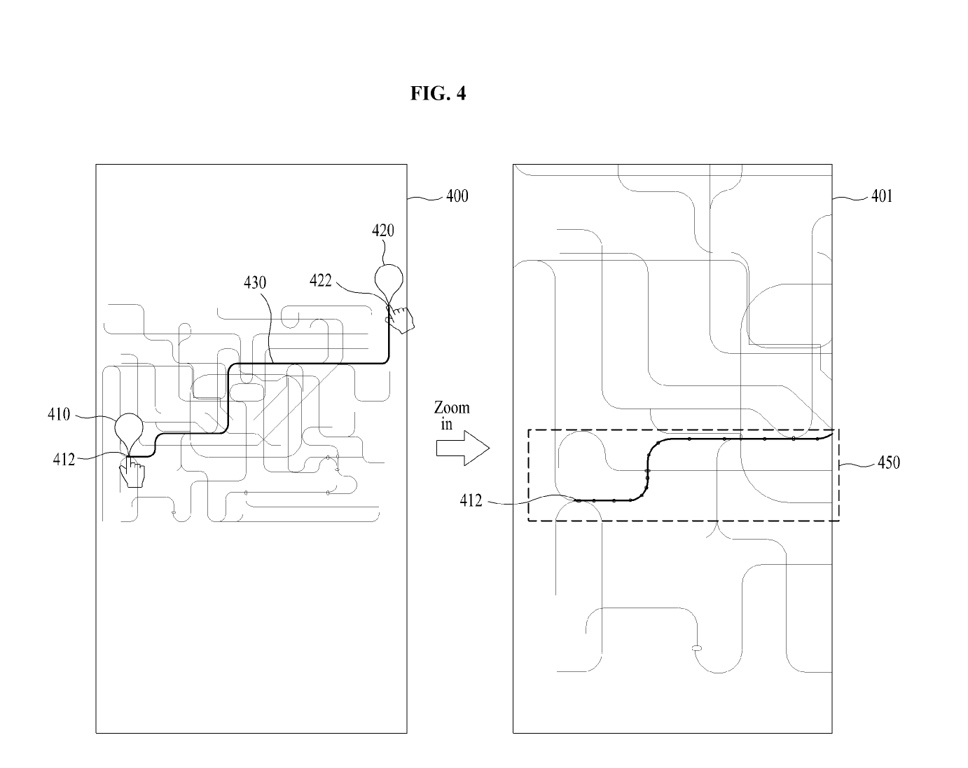

FIG. 4 illustrates an example of a zoom-in performed in a zoom control system 100 according to one exemplary embodiment.

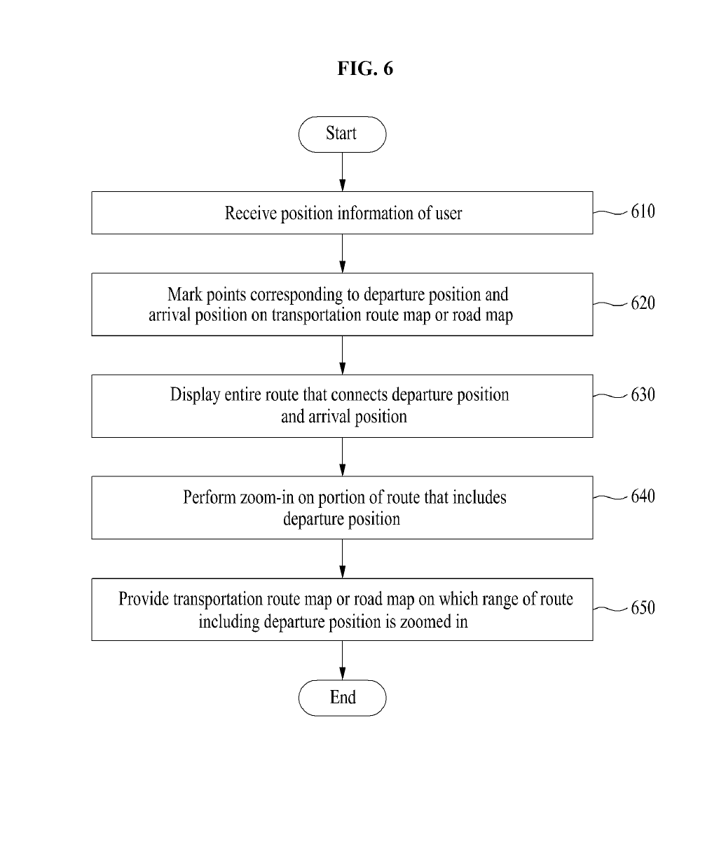

The zoom control system 100 may perform the zoom-in through operations 610 through 650 of FIG. 6. Referring to FIG. 6, in operation 610, identifier unit 211 receives position information of a user. Here, in response to the user inputting a position of the user through the user terminal 101, the zoom control system 100 receives position information associated with the input position.

In operation 620, the position information display unit 212 marks points corresponding to a departure position and an arrival position on a transportation route map or a road map. The information display unit 212 marks a departure position name in response to the departure position selected by the user and marks an arrival position name in response to the arrival position selected by the user.

In operation 630, the position information display unit 212 displays the entire route that connects the departure position and the arrival position. Here, the position information display unit 212 displays the entire route that connects a departure pin indicating the departure position and an arrival pin indicating the arrival position. The departure position name may be marked at the departure pin and the arrival position name may be marked at the arrival pin.

In operation 640, the executor unit 213 performs a zoom-in on the portion of the route that includes the departure position. The executor unit 213 enlarges a range of the route including the departure position by performing the auto zoom-in along the route including the departure position.

In operation 650, the executor unit 213 provides, to the user terminal 101, the transportation route map or the road map on which the range of route including the departure position is zoomed in, and the user terminal 101 may display the zoom-in transportation route map or road map through the display.

An example of the auto zoom-in method performed through operations 610 through 650 will be described with reference to FIG. 4. FIG. 4 illustrates a subway map and it is assumed that a user has executed a subway map application through the user terminal.

When the user initially executes a subway map application, the zoom control system 100 receives position information that includes a departure position associated with the user through the user terminal 101. For example, the position information associated with the user may be verified through GPS communication with the user terminal 101, or may be verified through communication between the user terminal and a base station.

The identifier unit 211 marks the position selected by the user on the subway map based on the position information. Here, the position information display unit 212 may provide the user with an interface for receiving information from the user, and the user may select the departure position and the arrival position. The position information display unit 212 marks a point corresponding to the departure position selected by the user and a point corresponding to the arrival position selected by the user. The position information display unit 212 marks a departure position name in response to the departure position selected by the user and may mark an arrival position name in response to the arrival position selected by the user. The position information display unit 212 displays the entire route that connects the departure position and the arrival position selected by the user on the subway map.

For example, in response to the user selecting Bupyeong station 412 as a departure position and selecting Chuncheon station 422 as an arrival station on the subway map 400, the position information display unit 212 may mark the selected departure position and arrival position on the subway map using pins 410 and 420. The position information display unit 212 may mark the pin 410 at Bupyeong station 412 and mark the pin 420 at Chuncheon station 422. The position information display unit 212 marks the pin 410 indicating Bupyeong station 412 selected by the user as “depart from Bupyeong” and may mark the pin 420 indicating Chuncheon station 422 as “arrive at Chuncheon”. The position information display unit 212 may display the entire route 430 that connects Bupyeong station 412 and Chuncheon station 422 selected by the user.

The executor unit 213 may zoom in the subway map 400 in response to displaying the entire route 430. The executor unit 213 may enlarge a range of the route 430 including position information by performing an auto zoom-in on a range of the route 430 that includes a departure position in the route 430. For example, the executor unit 213 may perform an auto zoom-in on a range of the route 430 that includes Bupyeong station 412 from the entire route 430 that connects Bupyeong station 412 and Chuncheon station 422. The range of the route 450 that includes Bupyeong station 412 may be zoomed in, that is, enlarged as a subway map 401 and displayed on the display of the user terminal 101.

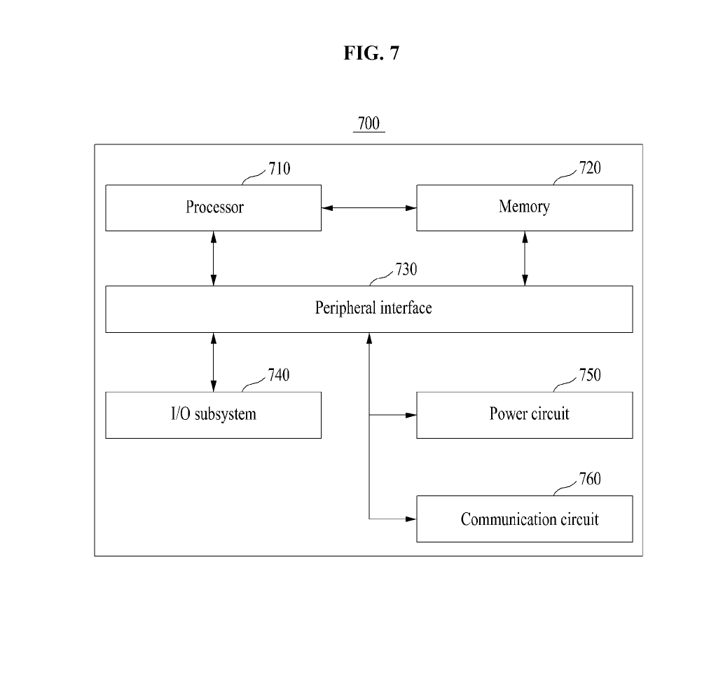

FIG. 7 is a block diagram illustrating a configuration of a computer system according to one example embodiment.

Referring to FIG. 7, a computer system 700 includes at least one processor 710, a memory 720, a peripheral interface 730, an input/output (I/O) subsystem 740, a power circuit 750, and a communication circuit 760. The computer system 700 may correspond to the user terminal 101.

The memory 720 may include, for example, a high-speed random access memory (HSRAM), a magnetic disk, a static random access memory (SRAM), a dynamic RAM (DRAM), read only memory (ROM), a flash memory, and a non-volatile memory. The memory 720 may include a software module, an instruction set, or a variety of data required for an operation of the computer system 700. Here, an access from another component such as the processor 710 and the peripheral interface 730 to the memory 720 may be controlled by the processor 710.

The peripheral interface 730 may couple an input device and/or an output device of the computer system 700 with the processor 710 and the memory 720. The processor 710 may perform a variety of functions for the computer system 700 and process data by executing the software module or the instruction set stored in the memory 720.

The I/O subsystem 740 may couple various I/O peripheral devices with the peripheral interface 730. For example, the I/O subsystem 740 may include a controller for coupling the peripheral interface 730 and a peripheral device, such as a monitor, a keyboard, a mouse, a printer, and a touch screen or a sensor depending on a necessity. The I/O peripheral devices may be coupled with the peripheral interface 730 without using the I/O subsystem 740.

The power circuit 750 may supply a power to all of or a portion of components of a terminal. For example, the power circuit 750 may include a power management system, at least one power source such as a battery and alternating circuit (AC), a charge system, a power failure detection circuit, a power converter or inverter, a power status indicator, or other components for creating, managing and distributing power.

The communication circuit 760 enables communication with another computer system using at least one external port. Alternatively, as described above, the communication circuit 760 may enable communication with another computer system by including a radio frequency (RF) circuit and thereby transmitting and receiving an RF signal known as an electromagnetic signal.

The embodiment of FIG. 7 is only an example of the computer system 700. The computer system 700 may have a configuration or an arrangement for omitting a portion of the components illustrated in FIG. 7, further including components not illustrated in FIG. 7, or coupling two or more components. For example, a computer system for a communication terminal of a mobile environment may further include a touch screen, a sensor, and the like, in addition to the components of FIG. 7. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 760. Components includable in the computer system 700 may be configured as hardware that includes an integrated circuit specified for at least one signal processing or application, software, or a combination of hardware and software.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A zoom control method, executed by a computer, for controlling a display area of a transportation route map or a road map, the method comprising:
identifying or receiving position information including a current position or a departure position associated with a user;
displaying the transportation route map or the road map including the position information on a display of a terminal;
determining that a preset period of time has elapsed from a display point in time displaying the transportation route map or the road map;
automatically zooming-out or zooming-in the transportation route map or the road map displayed on the display of the terminal after the preset period of time; and
displaying the zoomed-out or zoomed-in transportation route map or the zoomed-out or zoomed-in road map on the display of the terminal,
wherein the position information is marked on the zoomed-out or zoomed-in transportation route map or the zoomed-out or zoomed-in road map.

2. The method of claim 1, wherein the displaying of the transportation route map or the road map including the position information on the display of the terminal comprises marking a station close to the position information on the transportation route map or marking a point corresponding to the position information on the road map.

3. The method of claim 1, wherein the automatic zooming-out of the transportation route map or the road map reduces the transportation route map or the road map by a predetermined zoom level.

4. The method of claim 1, wherein the displaying of the transportation route map or the road map including the position information on the display of the terminal comprises providing an interface for receiving the position information, and marking a point on the transportation route map or the road map corresponding to a departure position selected by the user and a point on the transportation route map or the road map corresponding to an arrival position selected by the user.

5. The method of claim 4, wherein the displaying of the transportation route map or the road map including the position information on the display of the terminal comprises marking a departure position name on the transportation route map or the road map in response to the departure position selected by the user and an arrival position name on the transportation route map or the road map in response to the arrival position selected by the user.

6. The method of claim 5, wherein the displaying of the transportation route map or the road map including the position information on the display of the terminal comprises displaying an entire route connecting the departure position and the arrival position selected by the user.

7. The method of claim 1, wherein the displaying of the zoomed-out or zoomed-in transportation route map or the zoomed-out or zoomed-in road map on the display of the terminal comprises enlarging a range of a route including the position information by performing the zooming-in on the range of the route including the departure position.

8. The method of claim 7, wherein the displaying of the zoomed-out or zoomed-in transportation route map or the zoomed-out or zoomed-in road map on the display of the terminal comprises zooming-in on the route that connects the departure station and an arrival station selected by the user on the transportation route map.

9. A non-transitory computer readable medium storing instructions for controlling a display area of a transportation route map or a road map, wherein the instructions control a computer system to perform the steps comprising:
identifying or receiving position information including a current position or a departure position associated with a user;
displaying a transportation route map or a road map including the position information on a display of a terminal;
determining that a preset period of time has elapsed from a point in time displaying the transportation route map or the road map;
automatically zooming-out or zooming-in the transportation route map or the road map displayed on the display of the terminal after the preset period of time;
displaying the zoomed-out or zoomed-in transportation route map or the zoomed-out or zoomed-in road map on the display of the terminal,
wherein the position information in marked on the zoomed-out or zoomed-in transportation route map or the zoomed-out or zoomed-in road map.

10. A zoom control system configured as a computer, for controlling a display area of a transportation route map or a road map, comprising:
an identifier unit configured to identify or receive position information including a current position or a departure position associated with a user;
a position information display unit configured to display a transportation route map or a road map including the position information on a display of a terminal; and
an executor unit configured to determine that a preset period of time has elapsed from a point in time displaying the transportation route map or the road map, to automatically zoom-out or zoom-in the transportation route map or the road map displayed on the display of the terminal after the preset period of time, and to display the zoomed-out or zoomed-in transportation route map or the zoomed-out or zoomed-in road map on the display of the terminal,
wherein the executor unit is further configured to mark the position information on the zoomed-out or zoomed-in transportation route map or the zoomed-out or zoomed-in road map.

11. The zoom control system of claim 10, wherein the position information display unit is further configured to mark a station close to the position information on the transportation route map or mark a point corresponding to the position information on the road map.

12. The zoom control system of claim 10, wherein the executor unit is further configured to reduce the transportation route map or the road map by performing the automatic zoom-out based on a predetermined zoom level.

13. The zoom control system of claim 10, wherein the position information display unit is further configured to provide an interface for receiving the position information, and to mark a point on the transportation route map or the road map corresponding to a departure position selected by the user and a point on the transportation route map or the road map corresponding to an arrival position selected by the user.

14. The zoom control system of claim 13, wherein the position information display unit is further configured to mark a departure position name on the transportation route map or the road map in response to the departure position selected by the user and an arrival position name on the transportation route map or the road map in response to the arrival position selected by the user.

15. The zoom control system of claim 14, wherein the position information display unit is further configured to display an entire route connecting the departure position and the arrival position selected by the user.

16. The zoom control system of claim 10, wherein the executor unit is further configured to enlarge a range of a route including the position information by performing the zooming-in on the range of the route including the departure position.

17. The zoom control system of claim 16, wherein the executor unit is further configured to perform the zooming-in on the route that connects the departure station and an arrival station selected by the user on the transportation route map.
